(19) United States
(12) Patent Application Publication
(10) Pub. No.: US 2019/0359033 A1
(43) Pub. Date: Nov. 28, 2019

(54) HEAT MEDIUM HEATING DEVICE, AND VEHICULAR AIR CONDITIONING DEVICE

(71) Applicant: MITSUBISHI HEAVY INDUSTRIES THERMAL SYSTEMS, LTD., Tokyo (JP)

(72) Inventor: Tomoyasu Adachi, Tokyo (JP)

(73) Assignee: MITSUBISHI HEAVY INDUSTRIES THERMAL SYSTEMS, LTD., Tokyo (JP)

(21) Appl. No.: 16/485,687

(22) PCT Filed: Jan. 18, 2018
(86) PCT No.: PCT/JP2018/001368

§ 371 Date: Aug. 13, 2019

(30) Foreign Application Priority Data
Feb. 17, 2017 (JP) 2017-027931

(51) Int. Cl. B60H 1/22; B60H 1/03; F16J 15/14; H05B 1/02; B60H 1/26

(52) U.S. Cl. CPC B60H 1/2225; B60H 1/03; F16J 15/14; H05B 2203/021; B60H 1/26; H05B 2203/02; H05B 1/0236

(57) ABSTRACT

A second inclined portion (51A) including a second inclined face (51a) that expands a diameter of one end of a first communication port (51) is provided, and a width of the second inclined portion (51A) provided to one end of the first communication port (51) is made wider than a width of each of first inclined portions (49A, 50A) that expand diameters of an opening (49) and a recessed portion (50).

### TECHNICAL FIELD

The present invention relates to a heat medium heating device and a vehicular air conditioning device including the heat medium heating device.

This application claims priority based on JP 2017-027931 filed in Japan on Feb. 17, 2017, of which the contents are incorporated herein by reference.

### BACKGROUND ART

As a heat medium heating device that constitutes a known vehicular air conditioning device, there is a heat medium heating device including a PTC heater in which a Positive Temperature Coefficient (PTC) element serves as a heat generating element.

Patent Document 1 discloses a heat medium heating device including a PCT heater disposed between a first casing part in which a first heat medium flow path is formed and a second casing part in which a second heat medium flow path is formed.

In addition, Patent Document 1 discloses a communication portion including a first communication port and a second communication port, and in the communication portion, a heat medium moves between the first heat medium flow path and the second heat medium flow path.

The first communication port is provided in the first casing part and communicates with the first heat medium flow path. The second communication port is provided in a portion of the second casing part that faces the first communication port and is in communication with the second heat medium flow path.

### CITATION LIST

### Patent Literature

Patent Document 1: JP 2011-225074 A

### SUMMARY OF INVENTION

### Technical Problem

In the heat medium heating device including the above-described configuration, sealing between the first casing part and the second casing part is performed by interposing a liquid gasket between the first casing part and the second casing part.

In the case of sealing between the first casing part and the second casing part in this way by using the liquid gasket, there has been a possibility of the liquid gasket protruding inside the communication portion to narrow an opening diameter of the communication portion, and there has been a possibility of inhibition of a flow of a heat medium passing through the communication portion.

Thus, an object of the present invention is to provide a heat medium heating device and a vehicular air conditioning device capable of suppressing inhibition of a flow of a heat medium passing through a communication portion configured to bring a first heat medium flow path and a second heat medium flow path in communication with each other.

### Solution to Problem

To solve the above-described problem, a heat medium heating device according to an aspect of the present invention includes a casing including a first casing part including a first seal face formed into a flat face, a first heat medium flow path through which a heat medium flows, and a first communication port being in communication with the first heat medium flow path and adjacent to the first seal face in one end, a second casing part including a second seal face formed into a flat face facing the first seal face, a second heat medium flow path through which the heat medium flows, and a second communication port being in communication with the second heat medium flow path and being in communication with one end of the first communication port in one end adjacent to the second seal face, a communication portion including the first communication port and the second communication port, and at least one opening and a recessed portion provided in the first and second casing parts, a PTC heater accommodated in the casing and disposed between the first heat medium flow path and the second heat medium flow path, and a liquid gasket provided between the first seal face and the second seal face, and in the heat medium heating device, one end of the opening and the recessed portion is provided with a first inclined portion inclined with respect to the first seal face or the second seal face and including a first inclined face that expands a diameter of the opening or the recessed portion, either one end of the first communication port or one end of the second communication port is provided with a second inclined portion inclined with respect to the first seal face or the second seal face and including a second inclined face 51a that expands a diameter of one end of the first communication port or the second communication port, and a width of the second inclined portion is wider than a width of the first inclined portion.

According to the present invention, the width of the second inclined portion provided at one end of the first communication port is made wider than the width of the first inclined portion provided at one end of at least one opening and the recessed portion. Thus, the liquid gasket protruding from between the first seal face and the second seal face can be disposed in a gap formed between the second seal face facing the second inclined face and the second inclined face.

Accordingly, protrusion of the liquid gasket to the inside of the communication portion is suppressed, and narrowing of a diameter of the communication portion can be suppressed. Accordingly, inhibition of a flow of a heat medium flowing through the communication portion can be suppressed (specifically, suppression of increase in a loss of pressure and suppression of deterioration in distribution of the heat medium to the first and second heat medium flow paths).

In addition, in the heat medium heating device according to one aspect of the present invention, a width of the second inclined portion may be from 1.5 times or more to 2.5 times or less a width of the first inclined portion.

When the width of the second inclined portion is less than 1.5 times the width of the first inclined portion, volume of the gap formed between the second seal face and the second inclined face becomes small.

Accordingly, to retain the liquid gasket protruding from between the first seal face and the second seal face within the gap described above becomes difficult, and a possibility of the liquid gasket protruding inside the communication portion becomes high.

On the other hand, when the width of the second inclined portion is greater than 2.5 times the width of the first inclined portion, sufficiently securing the width of the first seal face or the second seal face disposed in the periphery of the second inclined portion becomes difficult. In such a case, there has been a possibility of decrease in sealing performance of the liquid gasket disposed between the first casing part and the second casing part.

Therefore, the width of the second inclined portion is set to be from 1.5 times or more to 2.5 times or less the width of the first inclined portion, and thus sealing performance of the liquid gasket disposed between the first casing part and the second casing part can be secured sufficiently, and inhibition of a flow of a heat medium flowing through the communication portion (inhibition due to the liquid gasket) can be suppressed.

In addition, a vehicular air conditioning device according to an aspect of the present invention may include the heat medium heating device described above, a blower configured to circulate an outside air or a cabin inside air, a cooler provided on a downstream side of the blower and configured to cool the outside air or the cabin inside air, and a radiator which is provided on a downstream side of the cooler and through which the heat medium heated by the PTC heater is circulated.

The vehicular air conditioning device includes the heat medium heating device in this way, and thus inhibition of a flow of a heat medium flowing through the communication portion in which the first heat medium flow path and the second heat medium flow path are in communication can be suppressed.

### Advantageous Effect of Invention

The present invention is capable of suppressing inhibition of a flow of a heat medium flowing through a communication portion in which a first heat medium flow path and a second heat medium flow path are in communication.

### BRIEF DESCRIPTION OF DRAWINGS

FIG. 1 is a view schematically illustrating a schematic configuration of a vehicular air conditioning device according to an embodiment of the present invention.

FIG. 2 is a perspective view illustrating an appearance of a heat medium heating device illustrated in FIG. 1.

FIG. 3 is a schematic cross-sectional view in an A₁-A₂ line direction of the heat medium heating device illustrated in FIG. 2.

FIG. 4 is a schematic cross-sectional view in a B₁-B₂ line direction of the heat medium heating device illustrated in FIG. 3.

FIG. 5 is a schematic cross-sectional view in a C₁-C₂ line direction of the heat medium heating device illustrated in FIG. 3.

FIG. 6 is an enlarged cross-sectional view of a portion enclosed in a region D of the heat medium heating device illustrated in FIG. 3.

FIG. 7 is a plan view of a first casing part, an insulating member, and an PTC heater.

FIG. 8 is an enlarged cross-sectional view of a portion enclosed in a region E of a structure illustrated in FIG. 6.

### DESCRIPTION OF EMBODIMENT

An embodiment of the present invention will be described below in detail with reference to the drawings.

### Embodiment

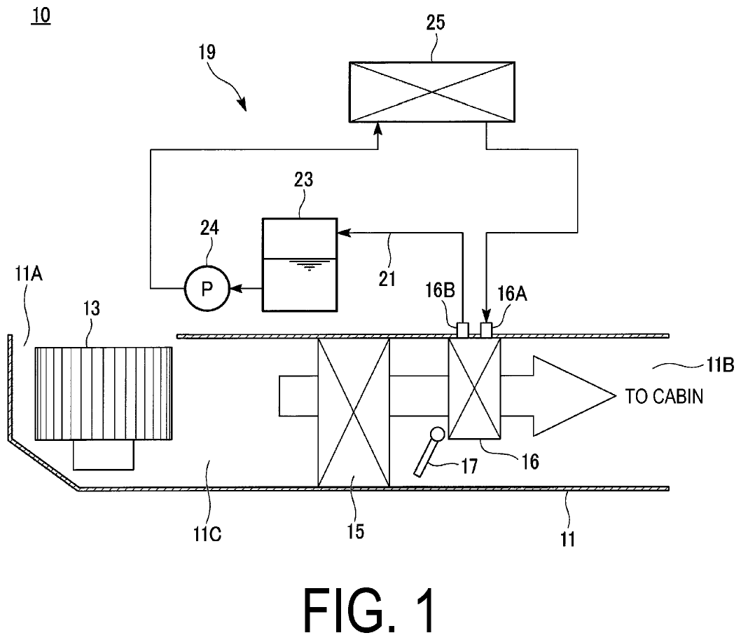

A vehicular air conditioning device 10 according to the present embodiment will be described with reference to FIG. 1. An arrow illustrated in FIG. 1 indicates a flow direction of an outside air or a cabin inside air.

The vehicular air conditioning device 10 is, for example, an air conditioning device that can be applied to a hybrid vehicle, an electric vehicle, and the like.

With reference to FIG. 1, a vehicular air conditioning device 10 includes a housing 11, a blower 13, a cooler 15, a radiator 16 constituting a heat medium circulation circuit 19, an air mixing damper 17, and the heat medium circulation circuit 19 including a heat medium heating device 25.

The housing 11 includes an intake port 11A, a discharge port 11B, and a flow path 11C. The intake port 11A is an opening configured to take an outside air or a cabin inside air (hereinafter simply referred to as “air”) into the flow path 11C.

The discharge port 11B is connected to a plurality of blown-out ports provided in the cabin for discharging air that has passed through the flow path 11 C. The flow path 11C is an air flow path defined in the housing 11.

The blower 13 is provided near the intake port 11A in the housing 11. The blower 13 sucks air from the intake port 11A and pumps air sucked to a downstream side of the blower 13.

The cooler 15 is provided in the housing 11 positioned on a downstream side of the blower 13. The cooler 15 is disposed to block a portion of the flow path 11C. The cooler 15 constitutes a refrigerant circuit together with a compressor, a condenser, and an expansion valve that are not illustrated. The cooler 15 cools air passing through the cooler 15 by evaporating a refrigerant adiabatically expanded by the expansion valve, and supplies air cooled to a downstream side of the cooler 15.

The radiator 16 constitutes the heat medium circulation circuit 19 together with a circulation line 21, a tank 23, a pump 24, an engine (not illustrated), and the heat medium heating device 25. The radiator 16 is provided in the flow path 11C positioned on the downstream side of the cooler 15.

The radiator 16 includes an inlet port 16A and an outlet port 16B connected to the circulation line 21. A heat medium is introduced through the circulation line 21 into the inlet port 16A via the heat medium heating device 25. The heat medium having passed through the radiator 16 is guided out of the outlet port 16B to the circulation line 21.

The radiator 16 exchanges heat between the air cooled by the cooler 15 and the heat medium to heat air and supplies air heated to the downstream side.

The air mixing damper 17 is provided in the flow path 11C positioned between the cooler 15 and the radiator 16. The air mixing damper 17 is a damper configured to adjust a ratio of an amount of air having passed through the radiator 16 to an amount of air flowing bypassing the radiator 16. The air mixing damper 17 has a function to adjust a temperature of air to be mixed on a downstream side of the air mixing damper 17.

The heat medium circulation circuit 19 includes the radiator 16, the circulation line 21, the tank 23, the pump 24, the engine (not illustrated), and the heat medium heating device 25.

The heat medium circulation circuit 19 heats an engine cooling fluid by the heat medium heating device 25 when a temperature of the engine cooling fluid which is the heat medium does not rise appreciably, for example during a hybrid operation and the like. Then, the engine cooling fluid heated is circulated through the circulation line 21 by the pump 24, to warm air passing through the radiator 16 inside the housing 11.

The circulation line 21 is disposed outside the housing 11. The circulation line 21 connects the radiator 16, the tank 23, the pump 24, the engine (not illustrated), and the heat medium heating device 25. The circulation line 21 is a line configured to circulate the heat medium.

When the vehicular air conditioning device 10 is applied to a hybrid vehicle, for example, an engine cooling fluid of a hybrid vehicle can be used as the heat medium. When the vehicular air conditioning device 10 is applied to an electric vehicle that does not include an engine, for example, a brine or the like can be used as the heat medium.

The tank 23 is provided on the circulation line 21 positioned on the outlet port 16B side. The heat medium is stored in the tank 23.

The pump 24 is provided on the circulation line 21 positioned on a downstream side of the tank 23. The pump 24 supplies the heat medium in the tank 23 to the heat medium heating device 25.

The heat medium heating device 25 is provided on the circulation line 21 positioned between the pump 24 and the radiator 16.

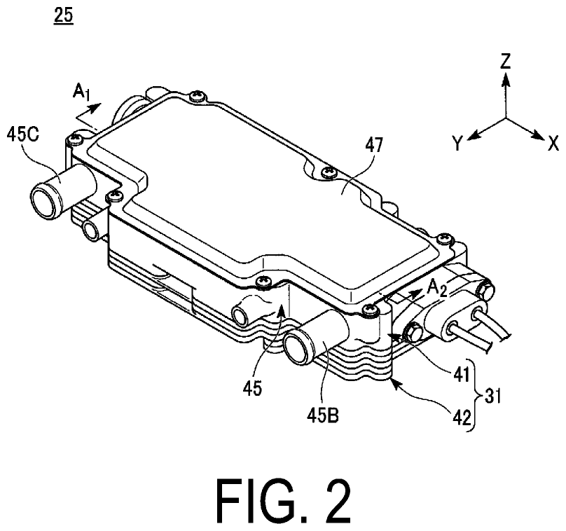

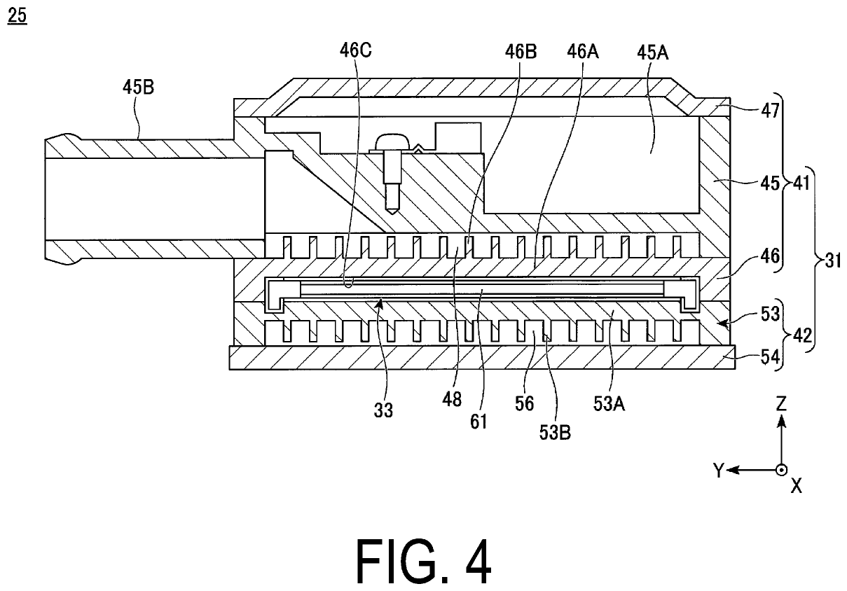

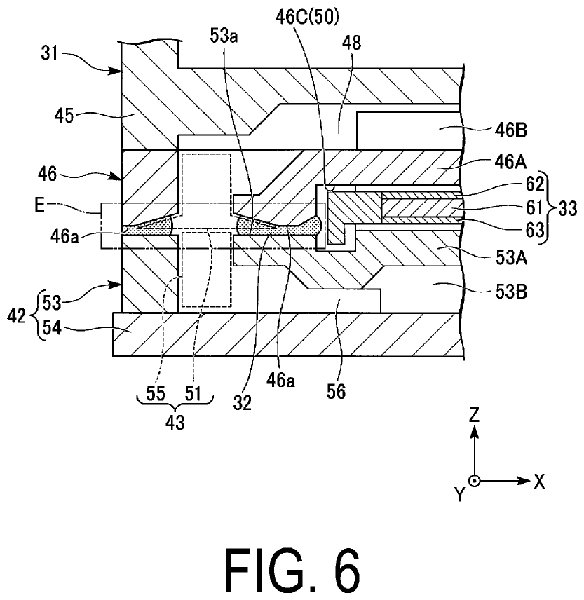

A configuration of the heat medium heating device 25 will be described with reference to FIGS. 2 to 8. In FIGS. 2 to 6 and FIG. 8, an X direction indicates a longitudinal direction of the heat medium heating device 25, a Y direction indicates a transverse direction of the heat medium heating device 25 orthogonal to the X direction, and a Z direction indicates a stacking direction of a PTC heater 33 and a control board 37 orthogonal to an X-Y plane (imaginary plane on which lines in the X direction and lines in the Y direction pass).

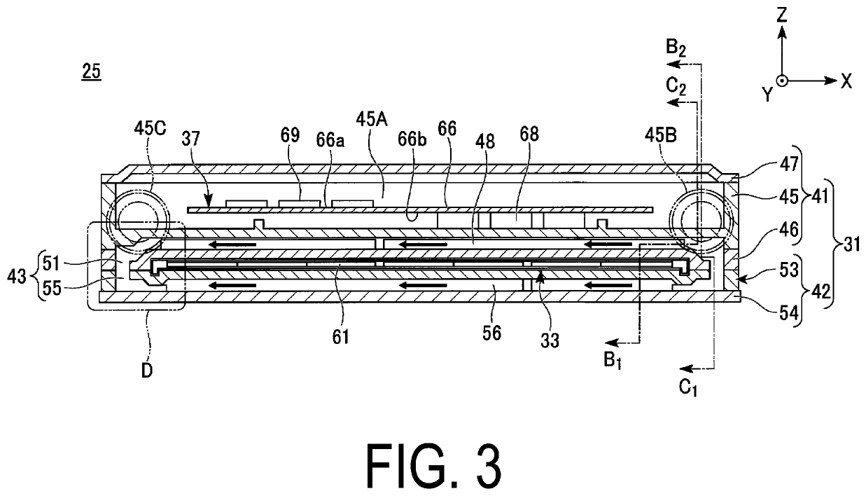

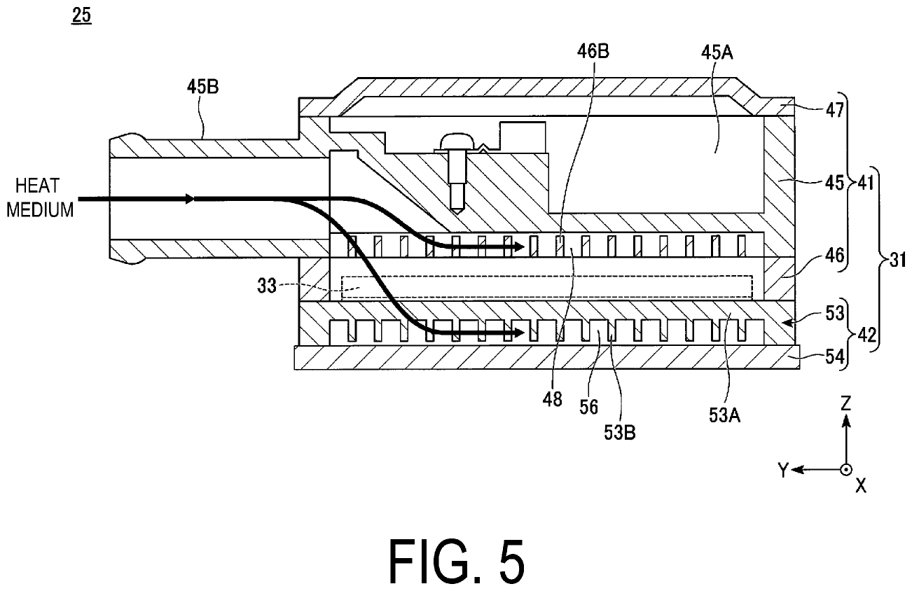

In FIGS. 2 to 8, the same constituent components are denoted by the same reference signs. Arrows illustrated in FIG. 3 indicate directions in which the heat medium flows. In addition, arrows indicated in FIG. 5 illustrate a state in which the heat medium flows into two branches.

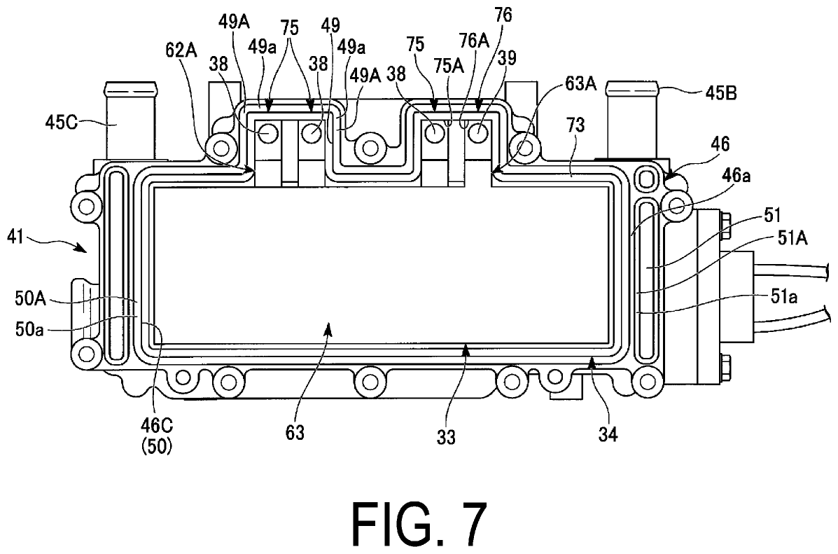

FIG. 7 illustrates, as an example of an opening 49, an opening in which first and second terminals 62A, 63A constituting first and second electrode plates 62, 63 of the PTC heater 33 are inserted.

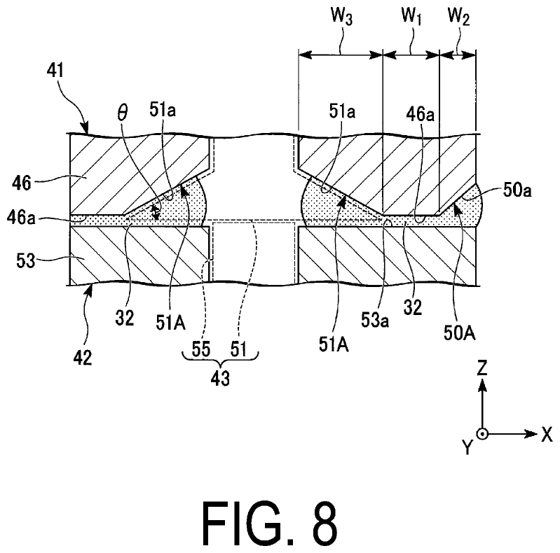

Further, in FIG. 8, Wi indicates a width of a first seal face 46a disposed in the periphery of a second inclined portion 51A (hereinafter referred to as a “width W₁”), W₂ indicates a width of a first inclined portion 50A (hereinafter referred to as a “width W₂”), and W₃ indicates a width of the second inclined portion 51A (hereinafter referred to as a “width W₃”).

The heat medium heating device 25 includes a casing 31, a liquid gasket 32, the PTC heater 33, an insulating member 34, and the control board 37.

The casing 31 includes a first casing part 41 including a first heat medium flow path 48, a second casing part 42 including a second heat medium flow path 56, and a communication portion 43 configured to bring the first and the second heat medium flow paths 48, 56 in communication with each other.

The first casing part 41 is separated from the second casing part 42. The first casing part 41 includes a board accommodating portion 45, a flow path-forming portion 46, and a lid portion 47.

The board accommodating portion 45 is provided between the flow path-forming portion 46 and the lid portion 47. The board accommodating portion 45 includes a board accommodating space 45A, a heat medium inlet port 45B, and a heat medium outlet port 45C. The board accommodating space 45A accommodates the control board 37.

The heat medium inlet port 45B is connected to the circulation line 21 that circulates the heat medium. The heat medium inlet port 45B introduces the heat medium into the first and second heat medium flow paths 48, 56 formed in the casing 31.

The heat medium outlet port 45C is connected to the circulation line 21. The heat medium outlet port 45C guides the heat medium having passed through the first and second heat medium flow paths 48, 56 provided in the casing 31 out to the circulation line 21.

The flow path-forming portion 46 includes a plate-shaped member 46A, a plurality of fins 46B, at least one opening 49 and a recessed portion 50, and a first communication port 51.

Note that one or more of each of the opening 49 and the recessed portion 50 may be provided.

The plate-shaped member 46A includes the first seal face 46a and a heater accommodating portion 46C. The first seal face 46a is a plane facing the second casing part 42. The first seal face 46a is a face facing a second seal face 53a that constitutes the second casing part 42.

The liquid gasket 32 that is a seal member is provided on the first seal face 46a. The width W₁ of the first seal face 46a can be set as appropriate.

The heater accommodating portion 46C is the recessed portion 50 in which the PTC heater 33 is accommodated. The PTC heater 33 faces the first heat medium flow path 48 in the Z direction by being accommodated in the heater accommodating portion 46C.

The plurality of fins 46B are provided on a side of the plate-shaped member 46A that faces the board accommodating portion 45. The plurality of fins 46B project in a direction oriented to the board accommodating portion 45.

The first heat medium flow path 48 is defined between the side on which the plurality of fins 46B are provided of the plate-shaped member 46A and the board accommodating portion 45. The first heat medium flow path 48 is a plurality of parallel flow paths through which the heat medium flows. The first heat medium flow path 48 is in communication with the heat medium inlet port 45B and the heat medium outlet port 45C. The first heat medium flow path 48 is disposed to face one face of the PTC heater 33.

The opening 49 is provided to penetrate the plate-shaped member 46A. One end of the opening 49 is adjacent to the first seal face 46a. A first inclined portion 49A including a first inclined face 49a that expands a diameter of the opening 49 is provided at one end of the opening 49.

The first inclined face 49a is a face that is inclined with respect to the first seal face 46a. The periphery of the first inclined face 49a is surrounded by the first seal face 46a. The liquid gasket 32 is disposed on the first inclined face 49a. The first inclined face 49a faces the second seal face 53a in the Z direction via the liquid gasket 32.

The recessed portion 50 is a recessed portion formed on the first seal face 46a side of the plate-shaped member 46A. One end of the recessed portion 50 is adjacent to the first seal face 46a. The first inclined portion 50A including a first inclined face 50a that expands a diameter of the recessed portion 50 is provided at one end of the recessed portion 50.

The first inclined face 50a is a face that is inclined with respect to the first seal face 46a. The periphery of the first inclined face 50a is surrounded by the first seal face 46a. The liquid gasket 32 is disposed on the first inclined face 50a. The first inclined face 50a faces the second seal face 53a in the Z direction via the liquid gasket 32.

The width W₂ of the first inclined portion 50A can be equal to a width of the first inclined portion 49A, for example.

As an example of the recessed portion 50, for example, the heater accommodating portion 46C, and a recessed portion and the like which is integrated with the heater accommodating portion 46C and in which a portion of the second casing part 42 is accommodated can be exemplified.

Note that, in the following description, a case in which the widths of the first inclined portions 49A, 50A are equal (that is, the width of each of the first inclined portions 49A, 50A is the width W₂) will be described as an example.

The first communication port 51 is in communication with the first heat medium flow path 48, and constitutes a portion of the communication portion 43. The first communication port 51 extends in the Z direction.

One end of the first communication port 51 is adjacent to the first seal face 46a. One end of the first communication port 51 is provided with the second inclined portion 51A inclined with respect to the first seal face 46a and including a second inclined face 51a that expands a diameter of one end of the first communication port 51. The periphery of the second inclined face 51a is surrounded by the first seal face 46a.

An inclination angle θ of the second inclined face 51a with respect to the first seal face 46a can be set to 30°, for example, but is not limited to this angle.

The width W₃ of the second inclined portion 51A (the width W₃ of a portion where the second inclined portion 51A is formed) may be made wider than the width W₂ of each of the first inclined portions 49A, 50A.

In this way, the width W₃ of the second inclined portion 51A is made wider than the width W₂ of each of the first inclined portions 49A, 50A, and thus the liquid gasket 32 that protrudes from between the first seal face 46a and the second seal face 53a can be disposed in a gap formed between the second seal face 53a that faces the second inclined face 51a in the Z direction and the second inclined face 51a.

Accordingly, protrusion of the liquid gasket 32 to the inside of the communication portion 43 is suppressed, and narrowing of a diameter of the communication portion 43 can be suppressed. Thus, inhibition of a flow of the heat medium flowing through the communication portion 43 can be suppressed (specifically, suppression of increase in a loss of pressure and suppression of deterioration in distribution of the heat medium to the first and second heat medium flow paths 48, 56).

In addition, the width W₃ of the second inclined portion 51A may be from 1.5 times or more to 2.5 times or less the width W₂ of each of the first inclined portions 49A, 50A.

When the width W₃ of the second inclined portion 51A is less than 1.5 times the width W₂ of each of the first inclined portions 49A, 50A, volume of a gap formed between the second seal face 53a and the second inclined face 51a becomes small. Accordingly, there is a possibility that retaining the liquid gasket 32 that protrudes from between the first seal face 46a and the second seal face 53a within the gap described above become difficult.

On the other hand, when the width W₃ of the second inclined portion 51A is greater than 2.5 times the width W₂ of each of the first inclined portions 49A, 50A, there is a possibility that sufficiently securing the width W₁ of the first seal face 46a disposed in the periphery of the second inclined portion 51A become difficult. In such a case, there is a possibility that sealing performance of the liquid gasket 32 disposed between the first casing part 41 and the second casing part 42 decrease.

Therefore, the width W₃ of the second inclined portion 51A is set to be from 1.5 times or more to 2.5 times or less the width W₂ of each of the first inclined portions 49A, 50A, and thus sealing performance of the liquid gasket 32 disposed between the first casing part 41 and the second casing part 42 can be ensured sufficiently, and in addition, inhibition of a flow of the heat medium flowing through the communication portion 43 (inhibition due to the liquid gasket 32) can be suppressed.

The lid portion 47 is separable with respect to the board accommodating portion 45. The lid portion 47 is secured by a screw. The lid portion 47 faces the control board 37 disposed in the board accommodating space 45A.

The second casing part 42 includes a flow path-forming portion 53 and a lid portion 54.

The flow path-forming portion 53 includes a plate-shaped member 53A, a plurality of fins 53B, at least one opening and a recessed portion (not illustrated), and a second communication port 55.

The plate-shaped member 53A includes the second seal face 53a. The second seal face 53a is a plane facing the first seal face 46a. The second seal face 53a faces the first inclined faces 49a, 50a and the second inclined face 51a in the Z direction. The liquid gasket 32 is disposed on the second seal face 53a.

The plurality of fins 53B are provided on a side of the plate-shaped member 53A that faces the lid portion 54. The plurality of fins 53B project in a direction oriented to the lid portion 54.

The second heat medium flow path 56 is defined between the side of the plate-shaped member 53A that is provided with the plurality of fins 53B and the lid portion 54. The second heat medium flow path 56 is a plurality of parallel flow paths in which the heat medium flows.

The second heat medium flow path 56 is in communication with the heat medium inlet port 45B and the heat medium outlet port 45C. The second heat medium flow path 56 is disposed to face the other face of the PTC heater 33.

The opening is provided to penetrate the plate-shaped member 53A. One end of the opening is adjacent to the second seal face 53a. The first inclined portion 49A described above is not provided at the one end of the opening. That is, the periphery of the opening is surrounded by the second seal face 53a.

The recessed portion is formed on the second seal face 53a side of the plate-shaped member 53A. One end of the recessed portion is adjacent to the second seal face 53a. The first inclined portion 50A described above is not provided at the one end of the recessed portion. That is, the periphery of the recessed portion is surrounded by the second seal face 53a.

The second communication port 55 is provided on the plate-shaped member 53A and extends in the Z direction. One end of the second communication port 55 is exposed from the second seal face 53a. The one end of the second communication port 55 faces one end of the first communication port 51.

The second communication port 55 is in communication with the second heat medium flow path 56 and the first communication port 51. The second communication port 55 together with the first communication port 51 constitutes the communication portion 43.

The second inclined portion 51A described above is not provided at the one end of the second communication port 55. That is, the periphery of the one end of the second communication port 55 is surrounded by the second seal face 53a.

The communication portion 43 is defined in the casing 31. The communication portion 43 includes the first and second communication ports 51, 55 disposed in the Z direction.

The communication portion 43 functions as a communication path through which the heat medium that moves between the first heat medium flow path 48 and the second heat medium flow path 56 flows.

The liquid gasket 32 is provided between the first seal face 46a and the second seal face 53a, and seals between the first casing part 41 and the second casing part 42.

A portion of the liquid gasket 32 protruding from between the first seal face 46a and the second seal face 53a is disposed between the first inclined faces 49a, 50a and the second seal face 53a, and between the second inclined face 51a and the second seal face 53a.

As described above, since the width W₂ of each of the first inclined portions 49A, 50A is smaller than the width W₃ of the second inclined portion 51A, the liquid gasket 32 protrudes outside the first inclined portions 49A, 50A. On the other hand, since the width W₃ of the second inclined portion 51A is wider than the width W₂ of each of the first inclined portions 49A, 50A, the liquid gasket 32 does not protrude outside the second inclined portion 51A.

As the liquid gasket 32, for example, an organic solvent-type liquid gasket, a solvent-free type liquid gasket, an aqueous type liquid gasket, or the like can be used.

As the organic solvent-type liquid gasket, for example, a modified alkyd-based liquid gasket, a cellulose ester-based liquid gasket, or a synthetic rubber-based liquid gasket can be used.

As the solvent-free type liquid gasket, for example, a phenol-based liquid gasket, a modified ester-based liquid gasket, a silicone-based liquid gasket, an acrylic-based liquid gasket, or the like can be used.

As the aqueous type liquid gasket, for example, an aqueous acrylic-based liquid gasket can be used.

The PTC heater 33 is accommodated in the heater accommodating portion 46C. The PTC heater 33 is disposed between the first heat medium flow path 48 and the second heat medium flow path 56. An PTC element 61, a first electrode plate 62, and a second electrode plate 63 are provided.

The PTC element 61 is a rectangular plate-shaped element and is disposed between the first electrode plate 62 and the second electrode plate 63.

The first electrode plate 62 is provided on one face of the PTC element 61 that faces the plate-shaped member 46A. The first electrode plate 62 includes an electrode plate main body formed in a plate shape, and three first terminals 62A. The electrode plate main body constituting the first electrode plate 62 is divided into three. The first terminals 62A are provided on the outer periphery of each of the electrode plate main bodies divided.

The first terminal 62A is provided on the outer periphery of the electrode plate main body constituting the first electrode plate 62. The first terminal 62A is screwed to the control board 37 by a first screw 38. Accordingly, the first terminal 62A is electrically connected to the control board 37.

The second electrode plate 63 is provided on the other face of the PTC element 61 that faces the flow path-forming portion 53. The second electrode plate 63 includes an electrode plate main body formed in a plate shape, and one second terminal 63A. The second terminal 63A is provided on the outer periphery of the electrode plate main body constituting the second electrode plate 63.

The second terminal 63A is screwed to the control board 37 by a second screw 39. Accordingly, the second terminal 63A is electrically connected to the control board 37.

The PTC heater 33 configured as described above heats the heat medium flowing through the first and second heat medium flow paths 48, 56. The heat medium heated by the PTC heater 33 is introduced into the radiator 16 through the inlet port 16A of the radiator 16.

Note that an insulating plate (not illustrated) is provided between the PTC heater 33 and the flow path-forming portions 46, 53. This insulating plate insulates between the PTC heater 33 and the flow path-forming portions 46, 53.

The insulating member 34 includes a frame 73, a first guide 75, and a second guide 76. The frame 73 is formed in a shape that surrounds a side face of a structure including the electrode plate main body of the first electrode plate 62, the PTC element 61, and the electrode plate main body of the second electrode plate 63.

The frame 73 is disposed between the flow path-forming portion 46 and the flow path-forming portion 53 in a state in which the frame 73 surrounds a side face of a stacked structure including the electrode plate main body of the first electrode plate 62, the PTC element 61, and the electrode plate main body of the second electrode plate 63. An outer peripheral face of the frame body 73 is in contact with an inner face of the heater accommodating portion 46C.

Three first guide portions 75 are provided on a long side of the frame 73. The two first guide portions 75 are provided adjacent to each other. The remaining one first guide portion 75 is provided at a position spaced apart from the other two first guide portions 75.

Each first guide portion 75 includes a first opening 75A extending in the Z direction. A first terminal 62A is inserted into the first opening 75A. The first guide portion 75 is formed in a shape that surrounds the first terminal 62A.

The first guide portion 75 configured in this way is provided, and thus insulation can be provided between a conductor disposed in the periphery of the first terminal 62A and the first terminal 62A.

One second guide portion 76 is provided on the long side of the frame 73 on which the first guide portions 75 are provided. The second guide portion 76 is disposed adjacent to one first guide portion 75.

The second guide portion 76 includes a second opening 76A extending in the Z direction. A second terminal 63A is inserted into the second guide portion 76. The second guide portion 76 is formed in a shape that surrounds the second terminal 63A.

The second guide portion 76 configured in this way is provided, and thus insulation can be provided between a conductor disposed in the periphery of the second terminal 63A and the second terminal 63A.

The insulating member 34 configured as described above is provided, and thus insulation can be provided between a conductor disposed in the periphery of the side face of the PTC heater 33, and the side face of the PTC heater 33, and positioning of the PTC heater 33 with respect to the control board 37 can be performed.

The control board 37 is accommodated in the board accommodating space 45A. The control board 37 includes a board main body 66, electronic components 68, 69, a first connection portion (not illustrated), and a second connection portion (not illustrated).

The board main body 66 is secured to the board accommodating portion 45. The board main body 66 includes a first face 66a and a second face 66b. The first face 66a is a face facing the lid portion 47. The second face 66b is a face disposed opposite the first face 66a. The second face 66b is a face facing the board accommodating portion 45.

The board main body 66 includes a configuration in which a circuit pattern (a control circuit pattern, a power supply circuit pattern, or the like) is formed on each of both faces of an insulated substrate formed in a plate shape.

The electronic component 68 is an electronic component that is more prone to heat generation than the electronic component 69. The electronic component 68 is provided on the second face 66b of the board main body 66. The electronic component 68 is electrically connected to the board main body 66. As the electronic component 68, an Insulated Gate Bipolar Transistor (IGBT) and a Field Effect Transistor (FET), and the like, can be exemplified.

The electronic component 69 is provided on the first face 66a of the board main body 66. The electronic component 69 is electrically connected to the board main body 66.

The first connection portion is provided on the second face 66b of the board main body 66. The first connection portion is electrically connected to the board main body 66. A terminal constituting the first electrode plate 62 is connected to the first connection portion.

The second connection portion is provided on the second face 66b of the board main body 66. The second connection portion is electrically connected to the board main body 66. A terminal constituting the second electrode plate 63 is connected to the second connection portion.

According to the heat medium heating device 25 of the present embodiment, the second inclined portion 51A including the second inclined face 51a that expands the diameter of one end of the first communication port 51 is provided, and the width W₃ of the second inclined portion 51A provided at one end of the first communication port 51 is made wider than the width W₂ of each of the first inclined portions 49A, 50A provided at one end of at least one opening 49 and the recessed portion 50. Thus, the liquid gasket 32 protruding from between the first seal face 46a and the second seal face 53a can be disposed in a gap formed between the second seal face 53a facing the second inclined face 51a in the Z direction and the second inclined face 51a.

Accordingly, protrusion of the liquid gasket 32 to the inside of the communication portion 43 is suppressed, and narrowing of a diameter of the communication portion 43 can be suppressed. Thus, inhibition of a flow of the heat medium flowing through the communication portion 43 can be suppressed (specifically, suppression of increase in a loss of pressure and suppression of deterioration in distribution of the heat medium to the first and second heat medium flow paths 48, 56).

In addition, the vehicle air conditioning device 10 of the present embodiment includes the heat medium heating device 25 described above, the blower 13 configured to circulate an outside air or a cabin inside air, the cooler 15 provided on the downstream side of the blower 13 and configured to cool the outside air or the air, and the radiator 16 which is provided on the downstream side of the cooler 15 and through which the heat medium heated by the PTC heater 33 is circulated, and thus inhibition of a flow of the heat medium flowing through the communication portion 43 in which the first heat medium flow path 48 and the second heat medium flow path 56 are in communication can be suppressed.

Note that in the present embodiment, the case in which the first and second inclined portions 49A, 50A, 51A are provided on the first seal face 46a side of the first casing part 41 is described as an example; however, the first and second inclined portions 49A, 50A, 51A may be provided on the second seal face 53a side of the second casing part 42.

That is, the first inclined portions 49A, 50A may be provided to surround one end of at least one opening and the recessed portion disposed on the second seal face 53a side of the flow path-forming portion 53, and the second inclined portion 51A may be provided to surround one end of the second communication portion 55.

In this case, the same effects as in the heat medium heating device 25 and the vehicular air conditioning device 10 of the present embodiment can be obtained.

Although the preferable embodiment of the present invention is described above in detail, the present invention is not limited to such a specific embodiment. Various modifications and changes can be made within the scope and the spirit of the present invention described in the claims.

### INDUSTRIAL APPLICABILITY

The present invention can be applied to a heat medium heating device and a vehicular air conditioning device including the heat medium heating device.

### REFERENCE SIGNS LIST

10 Vehicular air conditioning device

11 Housing

11A Intake port

11B Discharge port

11C Flow path

13 Blower

15 Cooler

16 Radiator

16A Inlet port

16B Outlet port

17 Air mixing damper

19 Heat medium circulation circuit

21 Circulation line

23 Tank

24 Pump

25 Heat medium heating device

31 Casing

32 Liquid gasket

33 PTC Heater

34 Insulating member

37 Control board

38 First screw

39 Second screw

41 First casing part

42 Second casing part

43 Communication portion

45 Board accommodating portion

45A Board accommodating space

45B Heat medium inlet port

45C Heat medium outlet port

46, 53 Flow path-forming portion

46a First seal face

46A, 53A Plate-shaped member

46B, 53B Fin

46C Heater accommodating portion

47, 54 Lid portion

48 First heat medium flow path

49 Opening

49a, 50a First inclined face

49A, 50A First inclined portion

50 Recessed portion

51 First communication port

51a Second inclined face

51A Second inclined portion

53a Second seal face

55 Second communication port

56 Second heat medium flow path

61 PTC element

62 First electrode plate

62A first terminal

63 Second electrode plate

63A Second terminal

66 Board main body

66a First face

66b Second face

68, 69 Electronic component

73 Frame

75 First guide portion

75A First opening

76 Second guide portion

76A Second opening

W₁ to W₃ Width

θ Inclination angle

1. A heat medium heating device comprising:
a casing including a first casing part including a first seal face formed into a flat face, a first heat medium flow path through which a heat medium flows, and a first communication port being in communication with the first heat medium flow path and adjacent to the first seal face in one end,
a second casing part including a second seal face formed into a flat face facing the first seal face, a second heat medium flow path through which the heat medium flows, and a second communication port being in communication with the second heat medium flow path and being in communication with one end of the first communication port in one end adjacent to the second seal face,
a communication portion including the first communication port and the second communication port, and at least one opening and a recessed portion provided in the first and second casing parts;
a PTC heater accommodated in the casing and disposed between the first heat medium flow path and the second heat medium flow path; and
a liquid gasket provided between the first seal face and the second seal face, wherein
one end of the opening and the recessed portion is provided with a first inclined portion inclined with respect to the first seal face or the second seal face and including a first inclined face that expands a diameter of the opening or the recessed portion,
either one end of the first communication port or one end of the second communication port is provided with a second inclined portion inclined with respect to the first seal face or the second seal face and including a second inclined face that expands a diameter of one end of the first communication port or the second communication port, and
a width of the second inclined portion is wider than a width of the first inclined portion.

2. The heat medium heating device according to claim 1, wherein a width of the second inclined portion is from 1.5 times or more to 2.5 times or less a width of the first inclined portion.

3. A vehicular air conditioning device comprising:
the heat medium heating device according to claim 1;
a blower configured to circulate an outside air or a cabin inside air;
a cooler provided on a downstream side of the blower and configured to cool the outside air or the cabin inside air; and
a radiator which is provided on a downstream side of the cooler and through which the heat medium heated by the PTC heater is circulated.

4. A vehicular air conditioning device comprising:
the heat medium heating device according to claim 2;
a blower configured to circulate an outside air or a cabin inside air;
a cooler provided on a downstream side of the blower and configured to cool the outside air or the cabin inside air; and
a radiator which is provided on a downstream side of the cooler and through which the heat medium heated by the PTC heater is circulated.
